(19) United States
(12) Patent Application Publication
(10) Pub. No.: US 2010/0143755 A1
(43) Pub. Date: Jun. 10, 2010

(54) Multi-Channel Fuel Reformer with Augmented Heat Transfer

(76) Inventors: Bernhard A. Fischer, Honeoye Falls, NY (US); David J. Ranelli, W. Henrietta, NY (US); David Schumann, Spencerport, NY (US)

Correspondence Address: DELPHI TECHNOLOGIES, INC;LEGAL STAFF - M/C 483-400-402, 5725 DELPHI DRIVE, PO BOX 5052, TROY, MI, 48007, US

(21) Appl. No.: 12/490,436

(22) Filed: Jun. 24, 2009

(51) Int. Cl. H01M 8/18

(52) U.S. Cl. 429/20

(57) ABSTRACT

A planar endothermic reformer assembly comprising only a few macrochannels rather than many microchannels as in the prior art. The macrochannels are arranged alternately in a stack for reforming and hot gas flow in a cross-flow reformer/heat exchanger. The assembly includes four manifolds. An external combustor supplies heat to the hot gas macrochannels in the reformer/heat exchanger stack for endothermic reforming, resulting in low temperature gradients in the reforming macrochannels. The macrochannels, having no dimension less than 2.0 mm, contain metal substrates for heat transfer as well as for support for the catalytic washcoat and may comprise packs of corrugated sheet metal such as Haynes or Inconell; packs of wire mesh; metallic foam made of Fecralloy, Haynes, Inconel, or higher conductivity material; or stacks of metallic felt material. The metallic substrates are brazed into the reforming channels and the hot flow channels to ensure maximum heat transfer for highest reforming efficiencies.

### RELATIONSHIP TO GOVERNMENT CONTRACTS

The present invention was supported in part by a US Government Contract, No. DE-FC26-02NT41246. The United States Government may have rights in the present invention.

### TECHNICAL FIELD

The present invention relates to reformers for producing hydrogen-containing reformate gas from hydrocarbon fuels; more particularly, to endothermic reformers having multiple flow channels; and most particularly, to a planar, macrochannel, heat exchange fuel reformer having augmented heat transfer.

### BACKGROUND OF THE INVENTION

Catalytic partial oxidation (CPOx) hydrocarbon reformers are well known in the art. Typically, such reformers partially oxidize hydrocarbon fuel to provide a mixture of hydrogen, carbon monoxide, and residual unreacted hydrocarbon, which partially oxidized fuel (known in the art as “reformate”) is suitable for use in a solid oxide fuel cell (SOFC) stack.

Catalytic reforming may proceed either exothermically or endothermically. In exothermic reforming, gaseous oxygen is supplied typically from air, and reforming generates excess heat. In endothermic reforming, atomic oxygen is derived from the decomposition of water, which requires the input of heat.

Exothermic reforming can deliver maximum reforming efficiencies of only about 78% to 80% for DF2, gasoline, or JP8 fuels, and up to 84% for methane and natural gas fuels at usual reactant preheat temperatures up to about 300° C. Only with SOFC stack fuel utilizations of greater than 80% can such a system deliver overall system efficiencies of greater than about 30% to 35%.

On the other hand, heat for endothermic reforming is known to be economically supplied by combusting a portion of the anode tailgas from the SOFC and re-reforming the remainder. An endothermic reformer and heat exchanger incorporating an integral combustor is known in the art as an Integrated Combustor/Reformer (ICR). Because the anode tailgas contains substantial unreacted hydrogen, endothermic reforming can yield apparent reforming efficiencies greater than 100%, which allows for stack fuel utilizations of 40% to 60% while delivering overall system efficiencies greater than 35%.

Such an endothermic heat exchange design requires high heat transfer capability; large surface area for washcoat admission, durability, and life of the substrate; and durability and adhesion of the catalytic washcoat to the substrate.

Prior art ICR endothermic reformers, whether planar or of other construct, typically comprise a very large number of microchannels, defined in prior art U.S. Pat. No. 6,969,506 B1 as channels having at least one dimension less than 1.0 mm. Although that patent discloses channels having a dimension as great as 2.0 mm, the patent teaches away from channels having at least one dimension greater than 1.0 mm. Accordingly, “macrochannels” as used herein should be taken to mean channels having no dimension measuring 2.0 mm or less, and preferably substantially greater.

Such prior art ICR reformers have shown maldistribution of heat and poor washcoat adhesion when coating flat sheet metal or when coating the structural housing of the reformer. During manufacture, relatively small amounts of washcoat are picked up, the distribution of the washcoat cannot be controlled as to where and how much of it is deposited, and the thermal expansion of the base metal can cause spalling of the washcoat within minutes or hours of operation. Thus, prior art microchannel planar reactors require expensive, high-temperature materials such as Haynes alloys because of large temperature gradients caused by integrated combustion and reforming within a single device.

Prior art microchannel planar reactors are complex and expensive, cannot be repaired after failure, and are susceptible to washcoat spalling and thermal imbalance.

Prior art microchannel reactors inherently suffer from maldistribution of flow through the individual combustor and reformer channels, which leads to poor reforming results and localized high temperatures. Prior art reactors have not demonstrated reforming efficiencies in the range of about 120% to about 150%.

What is needed in the art is an improved multi-channel fuel reformer that overcomes the above deficiencies and yields reforming efficiencies in the range of about 120% to about 150%.

It is a principal object of the present invention to provide reforming efficiencies in the range of about 120% to about 150%.

It is a further object of the present invention to reduce the manufacturing cost and improve the reliability of an endothermic hydrocarbon fuel reformer.

### SUMMARY OF THE INVENTION

Briefly described, a planar endothermic reformer in accordance with the present invention comprises only a few large planar channels rather than many microchannels as in the prior art. See, for example, active microchannel heat exchangers disclosed in U.S. Pat. Nos. 6,200,536 B1, 6,616,909, and 6,969,506 issued to Tonkovich et al., and U.S. Pat. No. 7,125,540 issued to Wegeng et al. Preferably, between five and ten macrochannels are arranged for reforming and hot gas flow as individual layers of a multi-layer cross-flow heat exchange configuration. The number of macrochannels and the number of reactors can be adapted for any size fuel cell and power demand. An external combustor supplies heat to the reformer/heat exchanger for endothermic reforming, resulting in lower temperature gradients within the reformer as compared to a prior art ICR. The lower temperature gradients allow all channels and manifolds to be formed of less expensive materials such as Inconel 625. Simple manifolding and the relatively few but large flow channels result in flows though the individual channels that are equal and uniform.

The required large heat transfer in each large channel is supported by augmentation of the natural convective and conductive channel heat transfer. Preferably, the channels contain metal substrates for heat transfer in all of the reforming and heating channels, as well as for support and substrate for the catalytic washcoat in the reforming channels. Such metal substrates may comprise, for example, packs of corrugated sheet metal such as Haynes or Inconell; packs of wire mesh; metallic foam made of Fecralloy, Haynes, Inconel, or higher conductivity material; or stacks of metallic felt material. Foams have proven especially good for washcoat pickup and washcoat adhesion. Preferably, the metallic substrates are brazed into the reforming channels and the hot flow channels to ensure maximum heat transfer for highest efficiencies.

### BRIEF DESCRIPTION OF THE DRAWINGS

The present invention will now be described, by way of example, with reference to the accompanying drawings, in which:

FIG. 1 is a plan view of a portion of a prior art ICR microchannel reactor (reformer) substantially as disclosed in U.S. Pat. No. 7,125,540 B1;

FIG. 2 is a schematic drawing of endothermic reforming and combustion processes in accordance with a reforming system of the present invention;

FIG. 3 is an exploded isometric drawing of a multi-channel heat exchanging reformer stack in accordance with the present invention;

FIG. 4 is an exploded isometric drawing of a complete multi-channel heat exchanging reformer taken at circle 4 in FIG. 2, including the reformer stack shown in FIG. 3; and

FIG. 5 is an isometric drawing showing in fully-assembled form the multi-channel heat exchanging reformer shown in FIG. 4.

Corresponding reference characters indicate corresponding parts throughout the several views. The exemplification set out herein illustrates one preferred embodiment of the invention, in one form, and such exemplification is not to be construed as limiting the scope of the invention in any manner.

### DESCRIPTION OF THE PREFERRED EMBODIMENTS

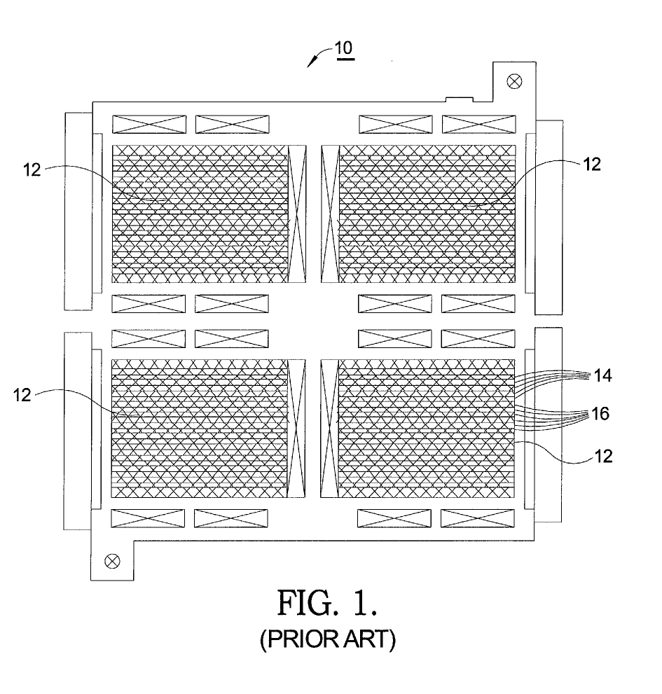

Referring to FIG. 1, a “shim” 10 of a prior art “compact microchannel steam reforming unit” substantially as disclosed in U.S. Pat. No. 7,125,540 B1, comprises a plurality of reaction chambers 12 formed by etching microchannels 14 to a depth of 5 mils (0.2 mm) into 20 mil (0.8 mm) thick stainless steel stock while leaving a series of struts 16 between the microchannels. Microchannels 14 average about 8 mils (0.4 mm) in width.

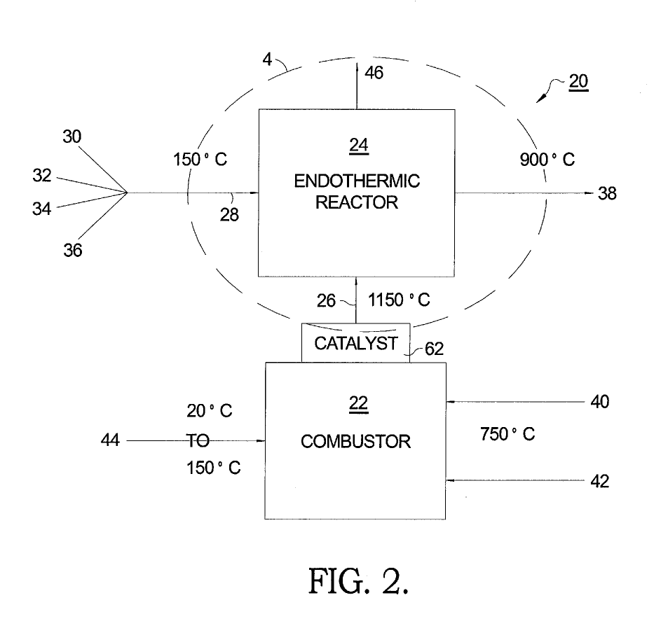

Referring now to FIG. 2, combustion and endothermic reforming processes and apparatus 20 in accordance with a reforming system of the present invention comprise a combustor 22 coupled to but separate from an endothermic catalytic reactor 24, also referred to here as an endothermic reformer. As described below, a catalytic reactor 24 in accordance with the present invention relies on an external combustor to supply the heat for endothermic reforming, thereby avoiding the high cost, complexity, and large internal thermal gradients exhibited by prior art ICR devices. Thus, separate combustor 22 supplies hot exhaust gases 26 to endothermic reactor 24.

Endothermic reactor 24 is supplied via a first port 28 with appropriate flows of gaseous hydrocarbon fuel 30, oxygen in the form of air 32, recycled (first portion) anode tailgas 34, and water in the form of steam 36, preferably at a temperature of about 150° C. Endothermic reactor 24 produces reformate 38 at a temperature of about 900° C. for use as a fuel in a fuel cell stack (not shown), for example, an SOFC stack. A second portion 40 of the anode tailgas from the fuel cell stack is sent to combustor 22, along with a portion of the cathode tailgas 42, typically at a temperature of about 750° C. Combustor 22 is further provided as may be needed with supplemental gaseous or pre-vaporized hydrocarbon fuel 44 to achieve a preferred combustion temperature of about 1150° C. Combustion gases are passed through endothermic reactor 24 which is arranged as a preferably cross-flow heat exchanger as described below and exhausted 46.

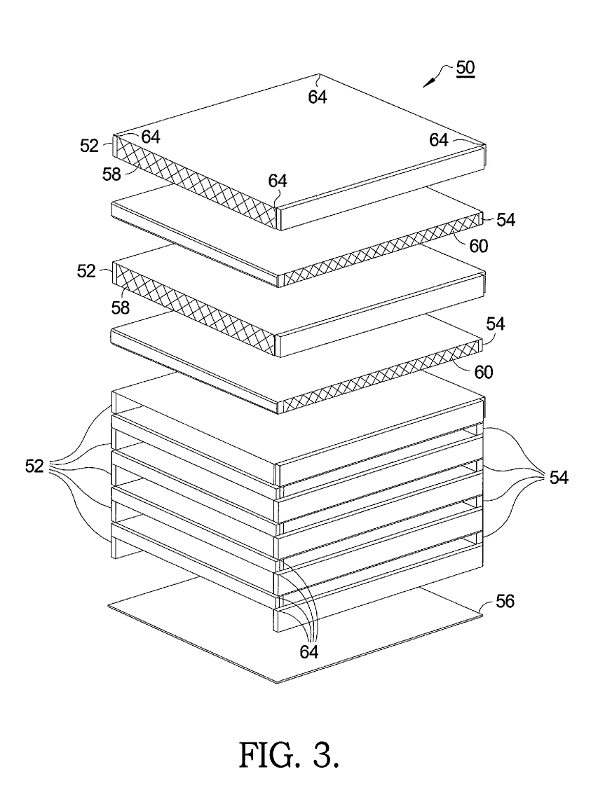

Referring now to FIG. 3, a multi-channel heat exchanging reformer stack 50 in accordance with the present invention comprises interleaved macrochannels 52,54 for conveying combustion gases and reforming gases, respectively, terminating in a bottom plate 56. Each macrochannel 52,54 preferably is formed in a simple U shape.

A planar reformer stack 50 in accordance with the present invention comprises only a few relatively large planar channels rather than a large number of microchannels as in the prior art. Preferably, between five and ten channels 52,54 are arranged for reforming and hot gas flow in a preferred cross-flow heat exchange configuration as shown in FIG. 3. Of course, other flow arrangements such as coflow and counterflow are fully comprehended by the invention. The number of channels and the number of reactors can be adapted easily for any size fuel cell and power demand. Hot flow macrochannels 52 are preferably between about 5 mm and about 15 mm in height, and reforming macrochannels 54 are preferably between about 2.5 mm and about 7.5 mm in height, depending upon application, flow, and power requirements. All macrochannels 52,54 may be of any desired width or length greater than 2.0 mm and may be formed of relatively inexpensive materials, for example, Inconel 625.

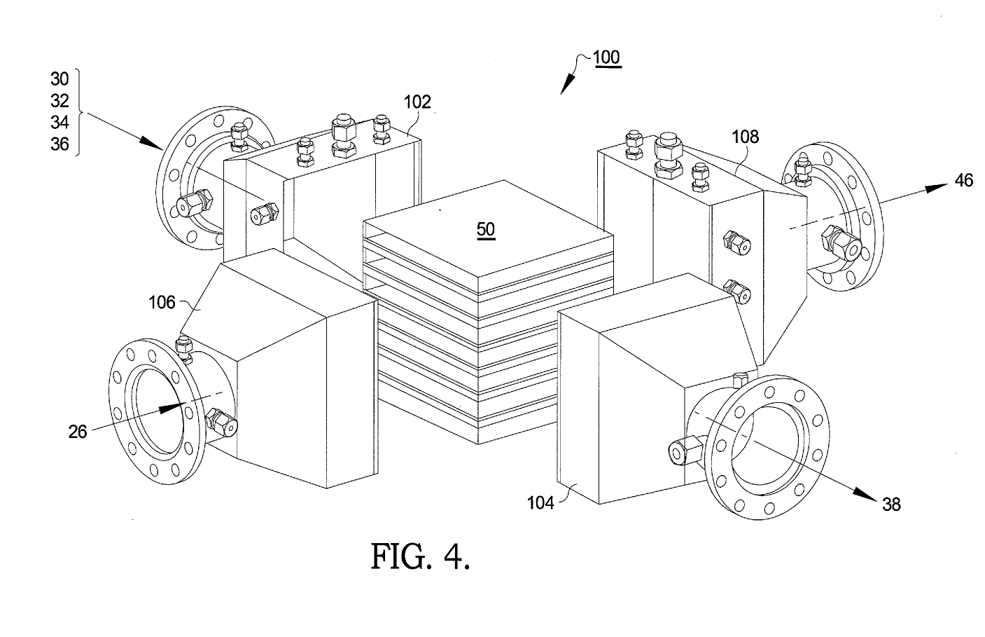

Preferably, each of macrochannels 52,54 contains a metal substrate 58,60 (omitted from the lower macrochannels 52,54 for clarity in FIGS. 3 and 4, but present in an actual stack 50) for heat transfer as well as forming a support and substrate for a catalytic washcoat in reforming channels 54. Such metal substrates may comprise, for example, packs of corrugated sheet metal such as Haynes or Inconel; packs of wire mesh; metallic foam made of Fecralloy, Haynes, Inconel, or higher thermal conductivity materials; or stacks of metallic felt material. Foams have proven especially suitable for washcoat pickup and adhesion. The metallic substrates 58,60 are fully brazed into both the hot flow and reforming macrochannels 52,54 to ensure maximum heat transfer for highest efficiencies. Optionally, substrate 58 within the heat exchanger hot flow path (combustor flow path) may be coated with a combustion catalyst 62 (FIG. 2) to ensure complete conversion of H₂ and CO for maximum heat generation and zero polluting emissions in exhaust 46.

Reformer 50 operates in exothermic reforming mode for system startup until endothermic reforming temperatures are achieved within the reformer, and then in endothermic reforming mode at fuel cell rated power conditions.

From a manufacturing standpoint, an important element of a stack 50 in accordance with the present invention is the simple and inexpensive forming of the parts. By forming and bending sheet material into simple u-shaped macrochannels 52,54 as shown in FIG. 3, metallic substrates 58,60 are fully contained on three sides, and subsequent brazing assures that all reactants travel through the metallic substrates, thus preventing “blow by” of reactants during the reaction process. This arrangement allows the metallic substrates to be brazed in place and the several alternating macrochannel layers 52,54 to be brazed together to create stack 50. Alternating macrochannels 52,54 are also brazed or welded together at their mating corners 64 to form stack 50.

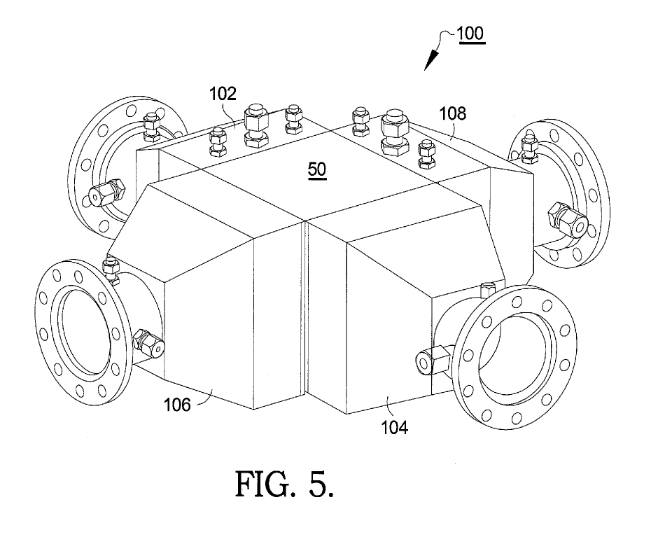

Referring now to FIGS. 4 and 5, a complete assembly 100 of an endothermic reactor in accordance with the present invention comprises stack 50 as described above and four ported manifolds 102,104,106,108 for supplying and exhausting respective reactants 26,30,32,34,36,46 and reformate 38 as described above. The manifolds are sufficiently copious that the various gases are presented to and exhausted from stack 50 at substantially uniform temperatures and pressures over the four flow-faces of the stack, thus ensuring equal flows of hot gases through each of the hot gas macrochannels 52 and equal flows of reactants through each of the reforming macrochannels 54. The manifolds also may be formed of relatively inexpensive materials, for example, Inconel 625.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A planar endothermic reformer assembly for reforming hydrocarbon fuel to provide reformate, comprising:
a) a plurality of macrochannels alternatingly arranged for endothermic reforming and hot gases, respectively, defining an integral heat exchanger and reformer stack wherein materials for reforming and hot gases for providing heat to said materials may flow through said alternatingly arranged macrochannels; and
b) a plurality of metallic substrates disposed within said plurality of endothermic reforming and hot gas macrochannels,
wherein at least one said metal substrates in said endothermic reforming macrochannels support a catalytic washcoat.

2. A planar endothermic reformer assembly in accordance with claim 1 further comprising a plurality of manifolds for supplying to said stack said reforming materials and said hot gases, and for exhausting from said stack said reformate and said hot gases.

3. A planar endothermic reformer assembly in accordance with claim 1 wherein said materials for reforming comprise hydrocarbon fuel, anode tailgas, and water.

4. A planar endothermic reformer assembly in accordance with claim 3 wherein said materials for reforming further comprise oxygen.

5. A planar endothermic reformer assembly in accordance with claim 1 wherein said macrochannels have no dimension less than 2.0 millimeter.

6. A planar endothermic reformer assembly in accordance with claim 5 wherein said macrochannels for hot gases are between about 5 mm and about 15 mm in height, and wherein said macrochannels for reforming are between about 2.5 mm and about 7.5 mm in height.

7. A planar endothermic reformer assembly in accordance with claim 1 wherein said macrochannels are formed of Inconel 625.

8. A planar endothermic reformer assembly in accordance with claim 1 wherein each of said macrochannels is formed from sheet metal stock.

9. A planar endothermic reformer assembly in accordance with claim 1 wherein each of said macrochannels is formed in the shape of a U.

10. A planar endothermic reformer assembly in accordance with claim 1 wherein said plurality of metallic substrates are secured within said plurality of endothermic reforming and hot gas macrochannels by brazing.

11. A planar endothermic reformer assembly in accordance with claim 1 wherein said plurality of macrochannels alternatingly arranged for endothermic reforming and hot gases are secured together via a method selected from the group consisting of brazing and welding.

12. A planar endothermic reformer assembly in accordance with claim 1 wherein said materials for reforming and said hot gases respectively pass through said stack in a flow arrangement selected from the group consisting of co-flow, cross-flow, and counter-flow.

13. A planar endothermic reformer assembly in accordance with claim 1 wherein at least one of said metallic substrates in said hot gas macrochannels are provided with catalyst for oxidizing hydrogen and carbon monoxide.

14. A planar endothermic reformer assembly in accordance with claim 1 wherein said metallic substrates are selected from the group consisting of packs of corrugated sheet metal such as Haynes or Inconel; packs of wire mesh; metallic foam made of Fecralloy, Haynes, Inconel, or higher thermal conductivity materials; stacks of metallic felt material; and combinations thereof.
